(19) United States
(12) Patent Application Publication
(10) Pub. No.: US 2026/0344880 A1
(43) Pub. Date: Nov. 5, 2026

(54) MOTION DRIVEN TRACK CLEANING SYSTEM

(71) Applicant: Caterpillar Inc., Peoria, IL (US)

(72) Inventor: Nicholas SIVERTSON, Tucson, AZ (US)

(21) Appl. No.: 19/195,560

(22) Filed: Apr. 30, 2025

(51) Int. Cl. A46B 15/00; A46B 13/00; A46B 13/02; B60M 7/00

(52) U.S. Cl. CPC A46B 15/0081; A46B 13/001; A46B 13/02; A46B 2200/3073; B60M 7/00

(57) ABSTRACT

A track cleaning system for a dynamic energy transfer system, the track cleaning system comprising: an angled scraper; a cleaning element having a cylindrical body with a central axis, and bristles disposed on the outer surface of the cylindrical body, proximate to the angled scraper; a roller mechanism with a cylindrical shape and a central axis with at least a driving surface in contact with the cleaning element; a tab structure with at least one slot to hold the angled scraper, the cleaning element, and the roller mechanism in place; and roller bracket engaged to the central axis of the slot in the tab structure, wherein the tab is engaged with a pushing mechanism connected to one or more powered rail of the dynamic energy transfer system.

### TECHNICAL FIELD

The embodiments described herein are generally directed to railway and track cleaners, and, more particularly, to a motion driven cleaning system for dynamic energy transfer rail systems.

### BACKGROUND

Heavy work machines, such as earth-moving vehicles or hauling trucks, require significant power to carry out their functions. The machines themselves can be of substantial weight, and their loads require large amounts of power to move. For electrical vehicles, battery-powered engines typically provide that power, but they can have disadvantages. At a remote mining site, for example, groups of these machines are often employed to ferry extreme loads along roadways, or haul routes, extending between various locations within the mining site. Therefore, a dynamic energy transfer rail system can provide power to machines while driving in and out of a worksite.

For a heavy work machine establishing and maintaining an electrical connection with the dynamic energy transfer rail system can be challenging when the dynamic energy transfer rail system is covered with debris, dirt, or snow. A motion driven railway cleaner can maintain the safety and efficiency of rail operations by removing debris, dirt, and snow from the dynamic energy transfer rail system. Further, a motion driven railway cleaner can use specialized cleaning elements such as brushes, scrapers, or plow configurations to clear the rails of obstructions, ensuring the dynamic energy transfer rail system have a smooth surface to provide power to machines. By preventing buildup that could reduce power transfer efficiency or create safety hazards, the motion driven railway cleaner enhances machine performance, reduces the risk of accidents, and improves overall operational reliability, especially in challenging weather conditions.

Accordingly, a motion driven railway cleaner, which is capable of cleaning a dynamic energy transfer rail system, would offer a variety of benefits. U.S. Patent No. CN103482331A and U.S. Pat. No. 1,124,226 A describe examples of railway cleaners. The present disclosure is directed toward overcoming one or more of the problems discovered by the inventor.

### SUMMARY

In an embodiment, a track cleaning system for a dynamic energy transfer system, the track cleaning system comprising: an angled scraper; a cleaning element having a cylindrical body with a central axis, and bristles disposed on the outer surface of the cylindrical body, proximate to the angled scraper; a roller mechanism with a cylindrical shape and a central axis with at least a driving surface in contact with the cleaning element; a tab structure with at least one slot to hold the angled scraper, the cleaning element, and the roller mechanism in place; and a roller bracket engaged to the central axis of the slot in the tab structure, wherein the tab is engaged with a pushing mechanism connected to one or more powered rail of the dynamic energy transfer system.

In an embodiment, a mobile equipment with track cleaning system for a dynamic energy transfer system, the track cleaning system comprising: an angled scraper; a cleaning element having a cylindrical body with a central axis, and bristles disposed on the outer surface of the cylindrical body, proximate to the angled scraper; a roller mechanism with a cylindrical shape and a central axis with at least a driving surface in contact with the cleaning element; a tab structure with at least one slot to hold the angled scraper, the cleaning element, and the roller mechanism in place; and a roller bracket engaged to the central axis of the slot in the tab structure, wherein the tab is engaged with a pushing mechanism connected to one or more powered rail of the dynamic energy transfer system.

In an embodiment, a motion driven energy railway cleaning device, comprising: an angled scraper; a cleaning element having a cylindrical body with a central axis, and bristles disposed on the outer surface of the cylindrical body, proximate to the angled scraper; a roller mechanism with a cylindrical shape and a central axis with at least a driving surface in contact with the cleaning element; a tab structure with at least one slot to hold the angled scraper, the cleaning element, and the roller mechanism in place; a roller bracket engaged to the central axis of the slot in the tab structure, wherein the tab is engaged with a pushing mechanism connected to one or more powered rail of the dynamic energy transfer system.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates a side view of a mobile equipment connected to a dynamic energy transfer rail system with a track cleaning system, according to an embodiment;

FIG. 2 illustrates an isometric view of a track cleaning system, according to an embodiment;

FIG. 3 Illustrates an isometric view of a dynamic energy transfer rail system with a track cleaning system, according to an embodiment;

FIG. 4 illustrates a top-view of a dynamic energy transfer rail system with a track cleaning system, according to an embodiment; and

FIG. 5 illustrates a close-up view of a track cleaning system, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details.

In some instances, well-known structures and components are shown in simplified form for brevity of description. For clarity and ease of explanation, some surfaces and details may be omitted in the present description and figures. It should also be understood that the various components illustrated herein are not necessarily drawn to scale. In other words, the features disclosed in various embodiments may be implemented using different relative dimensions within and between components than those illustrated in the drawings.

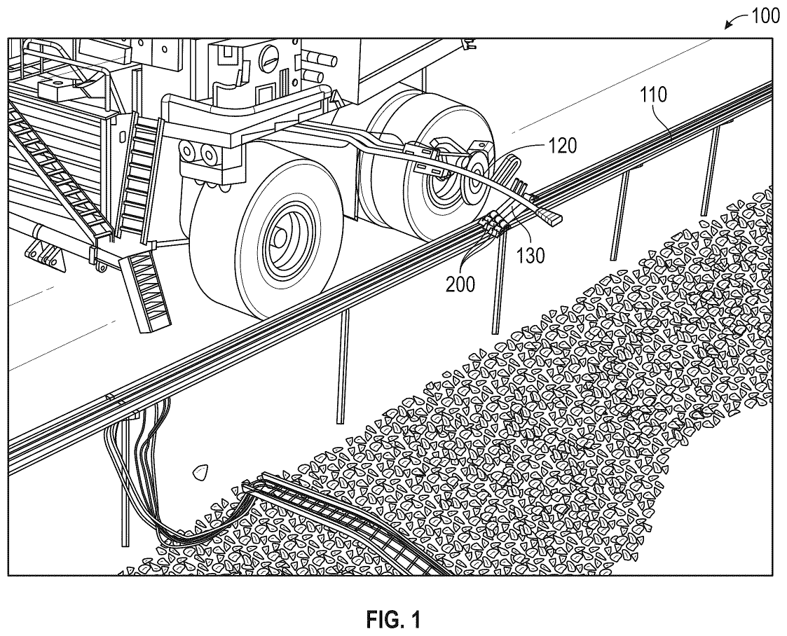

FIG. 1 illustrates a side view of a mobile equipment 100 connected to a dynamic energy transfer rail system with a track cleaning system 200, according to an embodiment. Mobile equipment 100 is illustrated as a modified wheel loader. However, mobile equipment 100 may be any equipment that can be energized by a dynamic energy transfer system. Other examples of mobile equipment 100 that could be modified to support swappable battery machinery include, without limitation, an excavator, dump truck, asphalt paver, backhoe loader, skid steer, track loader, cold planer, compactor, dozer, electric rope shovel, forest machine, hydraulic mining shovel, material handler, motor grader, pipe-layer, road reclaimer, telehandler, tractor-scraper, or the like. Mobile equipment 100 may be operated by a human (e.g., locally or remotely) and/or by an autonomous system.

In the illustrated example, mobile equipment 100 is energized by a dynamic energy transfer system. A dynamic energy transfer system is designed to provide dynamic continuous power to mobile equipment 100 while it is in operation, enhancing efficiency and reducing downtime. The electrical rail infrastructure includes a plurality of powered rails 110 installed to provide power along the working path of the mobile equipment 100 defined by the length of the driving surface 112 of powered rails 110. The plurality of powered rails 110 are designed to deliver continuous electrical power to mobile equipment's 100 charging system, facilitating efficient energy transfer. The plurality of electrified rails 104 may include three rails aligned in parallel equidistant apart. Further, the dynamic energy transfer system can include a pushing mechanism 120 with a connector 130 that connects pushing mechanism 120 with track or track cleaning system 200. Pushing mechanism 120 can be mechanically connected to tab structure 270 and/or roller bracket 250 with a spring 260 or tensor to maintain a constant kinetic energy transfer between roller mechanism 230 and pushing mechanism 120.

Track or track cleaning system 200 for a dynamic energy transfer system, the track cleaning system 200 comprises an angled scraper 210, a cleaning element 220 having a cylindrical body with a central axis 225. Further, the cleaning element can have bristles disposed on the outer surface of the cylindrical body, proximate to the angled scraper 210. In addition, track cleaning system 200 comprises a roller mechanism 230 with a cylindrical shape and a central axis 235 with at least a driving surface 112 in contact with the cleaning element 220. Angled scraper 210, cleaning element 220, roller mechanism 230 are held in place by a tab structure 270 with at least one slot 240, and a roller bracket 250 engaged to the central axis 235 of the slot 240 in the tab structure 270, wherein the roller bracket 250 is engaged with a pushing mechanism 120 connected to one or more powered rail 110 of the dynamic energy transfer system.

Track or track cleaning system 200 is designed to remove debris, dirt, and other contaminants from the tracks or rails of the dynamic energy transfer system to ensure smooth and safe power transfer operations. Track cleaning system 200 can use a combination of mechanical brushes, scrapers, or other elements to clean the powered rails 110 and driving surface 112 of the dynamic energy transfer system. Track cleaning system 200 helps maintain proper connection between powered rails 110 and connector 130, maintaining an efficient energy transfer between the dynamic energy transfer system and mobile equipment 100 by efficiently removing buildup of materials such as leaves, oil, rust, and dirt.

In addition to improving energy transfer efficiency, track cleaning system 200 can also reduce maintenance costs and downtime by keeping powered rails 110 in better condition. Regular cleaning prevents the accumulation of harmful substances that could lead to corrosion or degradation of powered rails 110 over time. Track cleaning system 200 can be coupled to a pushing mechanism 120 through connector 130 and connected to the mobile equipment 100 to cause track cleaning system 200 to move as mobile equipment 100 moves.

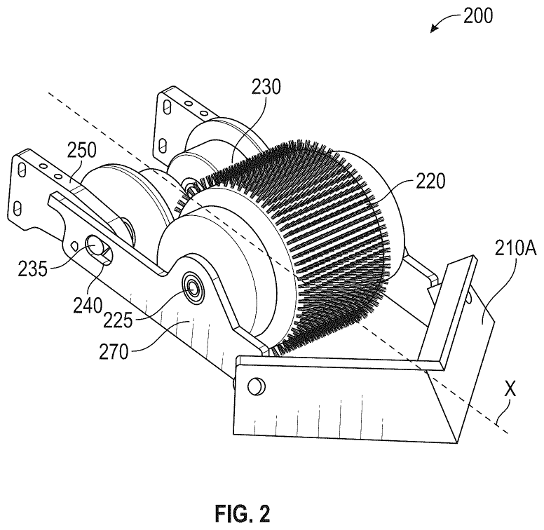

FIG. 2 illustrates an isometric view of a track cleaning system 200, according to an embodiment. As described in FIG. 1, The track or track cleaning system 200 for a dynamic energy transfer system, the track cleaning system 200 comprises an angled scraper 210, a cleaning element 220 having a cylindrical body with a central axis 225. Further, the cleaning element can have bristles disposed on the outer surface of the cylindrical body, proximate to the angled scraper 210. In addition, track cleaning system 200 comprises a roller mechanism 230 with a cylindrical shape and a central axis 235 with at least a driving surface 112 in contact with the cleaning element 220. Angled scraper 210, cleaning element 220, roller mechanism 230 are held in place by a tab structure 270 structure with at least one slot 240, and a roller bracket 250 engaged to the central axis 235 of the slot 240 in the tab structure 270, wherein the roller bracket 250 is engaged with a pushing mechanism 120 connected to one or more powered rail 110 of the dynamic energy transfer system.

Angled scraper 210 can be designed to clean powered rails 110 of the dynamic energy transfer system, and can be equipped with an angled blade or scraping mechanism that effectively removes dirt, debris, rust, and other contaminants from driving surface 112. Angled scraper 210 can be position at the front end of the track cleaning system 200 to ensure angled scraper 210 makes initial contact with powered rails 110 to begin the cleaning process before other components engage. As previously mentioned, angled scraper 210 can mounted in roller bracket 250 in a way that allows to follow the curvatures or shape of powered rail 110 while maintaining constant contact with driving surface 112 for optimal cleaning. Angled scraper 210 can be designed to reach and clean both the upper and side surfaces of powered rails 110, addressing areas that are hard to access through conventional cleaning methods, as shown in FIG. 2 (e.g. angled scraper 210A) The angles and shape of angled scraper 210 can mimic the shape of powered rails 110 to ensure the complete surface of powered rails 110 is cleaned. Alternatively, angled scraper 210 can have a plow configuration with blades positioned directly in front of track cleaning system 200 and in contact with powered rails 110 of the dynamic energy transfer system.

Further, track cleaning system 200 comprises a cleaning element 220 with a cylindrical body that can rotate about a central axis 225. Cleaning element 220 can be represented by a roller cleaner with bristles featuring a rotating cylindrical brush that is rotated by either a motor, mechanical coupling, or when in contact with roller mechanism 230. Also, cleaning element 220 can include an axle with two ends. Cleaning element 220 rotates, its bristles sweep across powered rails 110 to remove dirt, debris, and dust. The bristles can be designed with varying stiffness or angles to effectively capture and lift particles from different textures, including carpets, hard floors, or upholstery. The rotation ensures that the dirt is lifted and moved from driving surface 112. The motion of cleaning element 220 creates friction, which helps agitate driving surface 112 and dislodge stuck-on dirt while also preventing the bristles from becoming clogged with debris. This constant rotation can help a better power transfer between the dynamic energy transfer rail system and mobile equipment 100. Cleaning element 220 can be coupled to tab structure 270 from central axis 225 and allow a rotation of cleaning element 220 through a mechanism such as a bearing or a shaft that can enter a tab slot and be secured with a washer or any other mechanism.

Similar to cleaning element 220, roller mechanism 230 comprises a cylindrical shape and a central axis with at least a driving surface in contact with the cleaning element. Roller mechanism 230 can consist of a roller mounted on a central axis 235 or bearing, which comes into contact with driving surface 112, wherein roller mechanism 230 is configured to rotate in first direction, such that a rotation of roller mechanism 230 induces a rotation of cleaning element 220 in a second direction. Further, roller mechanism 230 can include an axle with two ends. Roller mechanism 230 can rotate when touching the surface of powered rails 110 use friction to rotate to have a smooth motion along driving surface 112. When force is applied, roller mechanism 230 rotates, enabling track cleaning system 200 to move with minimal resistance. Further, roller mechanism 230 can make cleaning element 220 rotate in the opposite direction of roller mechanism 230 through contact with an end of cleaning element 220 or a system like gears or band. For example, if roller mechanism 230 can be coupled to cleaning element 220 with a roller, pulley, belt, or gear that rotates in one direction, the adjacent roller, pulley, belt, or gear in cleaning element 220 will rotate in the opposite direction. Similarly, if roller mechanism 230 is in contact with a surface of cleaning element 220 with enough friction, the opposing force from the contact can make cleaning element 220 rotate in the opposite direction. Roller mechanism 230 can be coupled to roller bracket 250 and/or tab structure 270 from central axis 235 and allow a rotation of roller mechanism 230 through a mechanism such as a bearing or a shaft that can enter a tab slot 240 and be secured with a washer or any other mechanism. In addition, roller mechanism 230 can comprise one or more rings on either side of the cylindrical body with a larger diameter than a central diameter of the cylindrical body of the cleaning element, and in contact with the roller mechanism to ensure a constant contact between the least one end of cleaning element 220 and one end of roller mechanism 230.

Additionally, track cleaning system 200 comprises a tab structure 270 that can include one or more tab slots 240. Tab structure 270 can be designed with one or more tabs with precision-cut tab slots 240 that hold multiple components in place while allowing for controlled rotational movement of these components (e.g. cleaning element 220). Each component can be inserted into tab slot 240 within tab structure 270, and secured in place to provide a firm but flexible connection. The components, such as cleaning element 220 and roller mechanism 230, can be secured using washers or similar means. These washers can be strategically designed to allow slight rotational freedom, enabling the components to rotate around their central axis. Tab slots 240 can be customized in size and depth to fit a range of components, while the washer design prevents slippage and ensures that the components remain securely in place during rotation.

Furthermore, tab structure 270 can be arranged in a straight line or feature angles to hold the components at specific orientations, such as a central position, allowing for diverse configurations depending on track cleaning system 200 needs. For example, tab structure 270 can be designed at a slight angle, say 15 degrees, the components coupled in tab slots 240 after the angle shift will naturally shift to one side, creating an off-center alignment relative to the x-axis. Moreover, tab structure 270 can include an articulation mechanism that allows the tab structure to move in multiple directions relative to the center of track cleaning system 200. Tab structure 270 can be engaged through central axis 235 to roller bracket 250 connected to pushing mechanism. This arrangement can allow pushing mechanism 120 to transfer kinetic energy to track cleaning system 200 and move track cleaning system 200 as mobile equipment 100 moves.

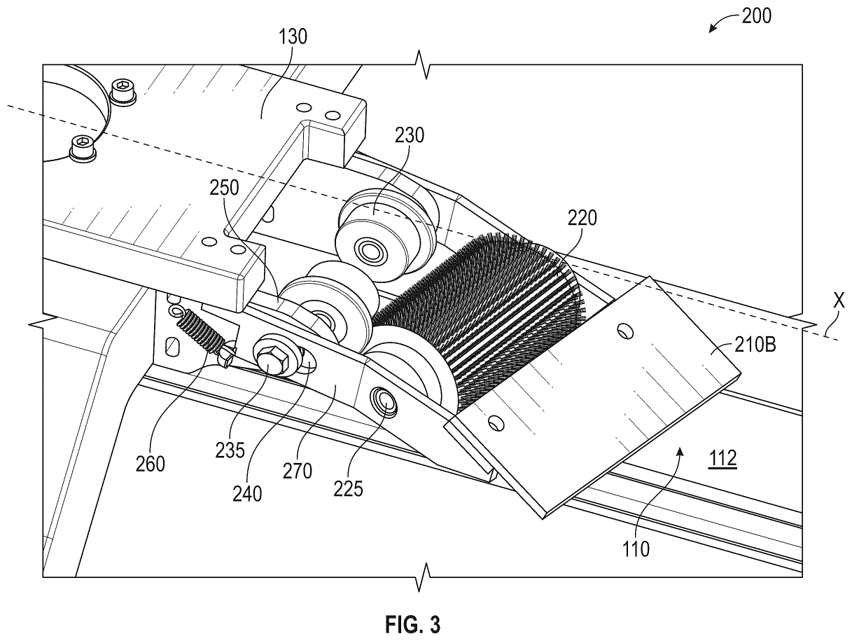

FIG. 3 Illustrates an isometric view of a dynamic energy transfer rail system with a track cleaning system 200, according to an embodiment. As illustrated in FIG. 3, track cleaning system 200 can be equipped with an angled scraper 210, which can be an adjustable angled blade or scraper that is designed to remove debris, such as dirt, rust, or snow, from driving surface 112 of powered rails 110. The angle of angled scraper 210B blade is designed to allow for efficient scraping while directing angled scraper 210 to apply a force towards the debris and directed downward and away from powered rail 110, making the cleaning process more effective. The angle in angled scraper 210B can be adjusted to adapt to different rail conditions or debris types, optimizing performance across various scenarios.

In some instances, as shown in FIG. 3, angled scraper 210B can be offset from the center of powered rail 110 when tab structure 270 is angled to either side of powered rail 110. This offset can allow for a more efficient and versatile cleaning action when removing larger debris or heavy snow accumulation. When angled scraper 210B is off-centered, debris can be directed away from powered rail 110 in a controlled manner. A simple plank-shaped angled scraper 210B can be used because the off-center positioning ensures that the debris is pushed to the side rather than just scraping off in a single direction. The offset angled scraper 210B allows the plank to effectively engage with driving surface 112.

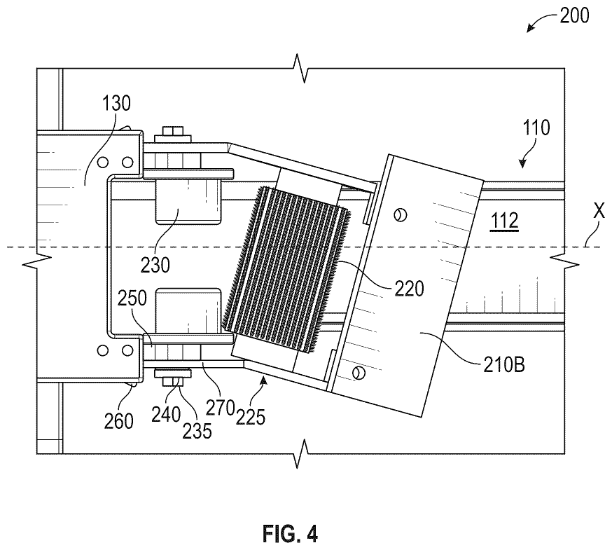

FIG. 4 illustrates a top-view of a dynamic energy transfer rail system with a track cleaning system 200, according to an embodiment. FIG. 4 shows a clear illustration of how angled scraper 210B is positioned off-center in relation to powered rail 110. In this example, angled scraper 210B is intentionally offset, allowing it to engage with driving surface 112 of powered rail 110 at an angle that maximizes debris removal efficiency. The angle can be created by the design in tab structure 270, which can have a slight angle on each side of tab structure 270. The off-center positioning ensures that angled scraper 210B interacts with driving surface 112 in a way that allows debris to be directed away from powered rail 110 rather than simply scraped off in a linear motion.

From the illustration in FIG. 3, cleaning element 220 is also in an offset position to optimize its cleaning action. As track cleaning system 200 moves along powered rail 110, angled scraper 210B makes contact with the surface, but because it is not centered, the debris is directed off to the side in a controlled manner. However, finer particles may not be removed. The interaction between cleaning element 220 and powered rail 110 ensures that cleaning element 220 effectively clears driving surface 112. Further, as shown in FIG. 3, at least a side of roller mechanism 230 is in contact with at least a side of cleaning element 220. Cleaning element 220 is enhanced by the off-center position, ensuring that the debris removal process is both efficient and straightforward as it follows angled scraper 210B.

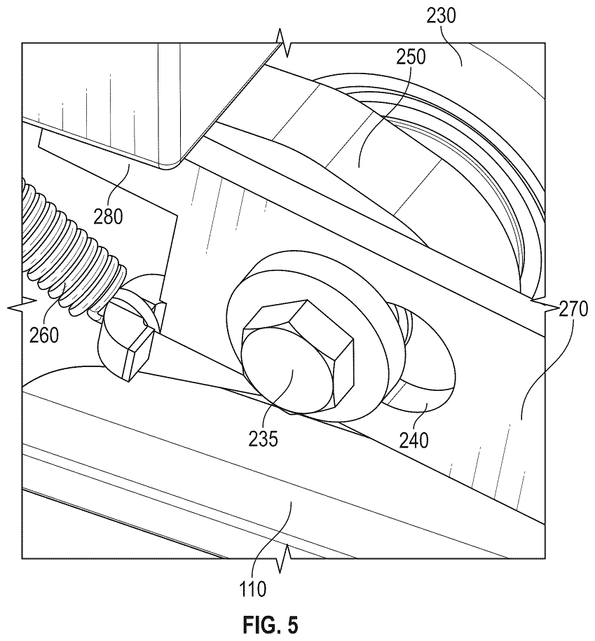

FIG. 5 illustrates a close-up view of a track cleaning system 200, according to an embodiment. As shown, FIG. 5 focuses on the interaction between tab structure 270, roller bracket 250, roller mechanism 230, and central axis 235. Roller mechanism 230 can be secured to roller bracket 250 on central axis 235, and can allow roller mechanism 230 to freely rotate around central axis 235, driven through contact with powered rails 110. The tab structure 270 is secured to the central axis 235 by the tab slot 240 of tab structure 270. Central axis 235 can serve as the central pivot, enabling tab structure 270 to pivot around roller mechanism 230 which can rotate independently from tab structure 270. A locking mechanism, such as a washer, can be used to secure central axis 235 in place, preventing any lateral movement or dislodgement of central axis 235 from tab slot 240. The tab slot 240 can allow rotation and tensioning of tab structure 270 about the central axis 235.

Further, tensioner 260 can pull tab structure 270 towards central axis 235. The action of tensioning allows for constant contact between roller mechanism 230 and cleaning element 220. For example, over time, cleaning element 220 can wear, decreasing the diameter of the contact surface, and tensioner 260 can increase the risk of sliding tab structure 270 closer to central axis 235 for continued contact between the roller mechanism 230 and the cleaning element 220. Additionally, the off-center design of tensioner 260 allows for rotation and downward force of tab structure 270, this ensures contact with the cleaning element 220 and plow 210 onto an uneven driving surface 112. If track cleaning system 200 were to have no powered rail 110 underneath, restriction tab 280 can stop track cleaning system 200 from over rotating. For example, when the pushing mechanism 130 is floating in the air, track cleaning mechanism 200 can be designed to drop until restriction tab 280 stops rotation of the tab structure 270. As a result, track cleaning mechanism 200 will never sit vertically. Once track cleaning mechanism 200 is on a powered rail 110, if powered rail 110 increases in elevation, tab structure 270 can rotate to match the curve.

### INDUSTRIAL APPLICABILITY

In some industrial contexts, mobile equipment 100, such as earth-moving vehicles or hauling trucks, require substantial power to perform their tasks, as they are often large in size and carry heavy loads. For electric mobile equipment 100, battery-powered engines typically supply this power, though they may present some limitations. Maintaining a reliable electrical connection with the rail system can be difficult when the rails are obstructed by debris, dirt, or snow. To address this challenge, track cleaning system 200 can be employed to remove such blockages and maintain the smooth operation of the system. Equipped with specialized cleaning elements like brushes, scrapers, or plows, the cleaner ensures that the rails remain clear, preventing disruptions to power transfer, reducing safety hazards, and improving operational efficiency, particularly under harsh weather conditions. Track cleaning system 200 can be motion-driven by the movement of mobile equipment 100. This system enhances machine performance, minimizes the risk of accidents, and bolsters overall reliability in demanding environments.

The track or track cleaning system 200 for a dynamic energy transfer system, the track cleaning system 200 comprises an angled scraper 210, a cleaning element 220 having a cylindrical body with a central axis 225. Further, the cleaning element can have bristles disposed on the outer surface of the cylindrical body, proximate to the angled scraper 210. In addition, track cleaning system 200 comprises a roller mechanism 230 with a cylindrical shape and a central axis 235 with at least a driving surface 112 in contact with the cleaning element 220. Angled scraper 210, cleaning element 220, roller mechanism 230 are held in place by a tab structure 250 structure with at least one slot 240, wherein the tab structure 270 and/or roller bracket 250 are engaged with a pushing mechanism 120 connected to one or more powered rail 110 of the dynamic energy transfer system.

The ability to quickly clean the railways or tracks in a dynamic energy transfer system provides increased productivity. For instance, mobile equipment 100 receives a more efficient energy transfer from powered rails 110 through connector 130. Additionally, the dynamic energy transfer system can maintain a constant contact with powered rails 110.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of machine or mobile equipment. Hence, although the present embodiments are, for convenience of explanation, depicted and described as being implemented in a motion driven railway cleaner, it will be appreciated that it can be implemented in various other types of equipment and tracks, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A track cleaning system for a dynamic energy transfer system, the track cleaning system comprising:
an angled scraper;
a cleaning element having a cylindrical body with a central axis, and bristles disposed on an outer surface of the cylindrical body, proximate to the angled scraper;
a roller mechanism with a cylindrical shape and a central axis with at least a driving surface in contact with the cleaning element;
a tab structure with at least one slot to hold the angled scraper, the cleaning element, and the roller mechanism in place; and
a roller bracket engaged to the central axis of the slot in the tab structure,
wherein the roller bracket is engaged with a pushing mechanism connected to one or more powered rail of the dynamic energy transfer system.

2. The system of claim 1, wherein the roller mechanism is configured to rotate in a first direction, such that a rotation of the roller mechanism induces a second rotation of the cleaning element in a second direction.

3. The system of claim 1, further comprising one or more rings on either side of the cylindrical body with a larger diameter than a central diameter of the cylindrical body of the cleaning element, and in contact with the roller mechanism.

4. The system of claim 1, wherein the pushing mechanism is driven by a motion of a mobile equipment.

5. The system of claim 1, wherein the roller mechanism rotates by a contact motion of the driving surface with a surface of one or more powered rails of the dynamic energy transfer system.

6. The system of claim 1, further comprising a cleaning element axle with two ends and a roller mechanism axle with two ends, wherein the ends are connected through the roller bracket at different distances, wherein at least one end of the roller mechanism is in contact with one end of the cleaning element.

7. The system of claim 1, wherein the roller mechanism comprises a roller, pulley, belt, or gear mechanically coupled to the cleaning element to rotate the cleaning element.

8. The system of claim 1, wherein the roller mechanism is mechanically connected to the pushing mechanism with a spring or tensor to maintain a constant kinetic energy transfer between the roller mechanism and the pushing mechanism.

9. The system of claim 1, wherein the cleaning element has a plow configuration with blades positioned directly in front of the track cleaning system and in contact with the powered rail of the dynamic energy transfer system.

10. The system of claim 1, wherein the tab structure further comprises an articulation mechanism configured to allow the roller bracket to move in multiple directions relative to the track cleaning system.

11. A mobile equipment with track cleaning system for a dynamic energy transfer system, the track cleaning system comprising:
an angled scraper;
a cleaning element having a cylindrical body with a central axis, and bristles disposed on an outer surface of the cylindrical body, proximate to the angled scraper;
a roller mechanism with a cylindrical shape and a central axis with at least a driving surface in contact with the cleaning element;
a tab structure with at least one slot to hold the angled scraper, the cleaning element, and the roller mechanism in place; and
a roller bracket engaged to the central axis of the slot in the tab structure,
wherein the roller bracket is engaged with a pushing mechanism connected to one or more powered rail of the dynamic energy transfer system.

12. The mobile equipment of claim 11, wherein the roller mechanism is configured to rotate in a first direction, such that a rotation of the roller mechanism induces a second rotation of the cleaning element in a second direction.

13. The mobile equipment of claim 11, further comprising one or more rings on either side of the cylindrical body with a larger diameter than a central diameter of the cylindrical body of the cleaning element, and in contact with the roller mechanism.

14. The mobile equipment of claim 11, wherein the roller mechanism rotates by a contact motion of the driving surface with a surface of one or more powered rails of the dynamic energy transfer system.

15. The mobile equipment of claim 11, further comprising a cleaning element axle with two ends and a roller mechanism axle with two ends, wherein the ends are connected through the roller bracket at different distances, wherein at least one end of the roller mechanism is in contact with one end of the cleaning element.

16. A motion driven energy railway cleaning device, comprising:
an angled scraper;
a cleaning element having a cylindrical body with a central axis, and bristles disposed on an outer surface of the cylindrical body, proximate to the angled scraper;
a roller mechanism with a cylindrical shape and a central axis with at least a driving surface in contact with the cleaning element;
a tab structure with at least one slot to hold the angled scraper, the cleaning element, and the roller mechanism in place; and
a roller bracket engaged to the central axis of the slot in the tab structure,
wherein the tab is engaged with a pushing mechanism connected to one or more powered rail of a dynamic energy transfer system.

17. The device of claim 16, wherein the roller mechanism is configured to rotate in a first direction, such that a rotation of the roller mechanism induces a second rotation of the cleaning element in a second direction.

18. The device of claim 16, further comprising one or more rings on either side of the cylindrical body with a larger diameter than a central diameter of the cylindrical body of the cleaning element, and in contact with the roller mechanism.

19. The device of claim 16, wherein the roller mechanism rotates by a contact motion of the driving surface with a surface of one or more powered rails of the dynamic energy transfer system.

20. The device of claim 16, further comprising a cleaning element axle with two ends and a roller mechanism axle with two ends, wherein the ends are connected through the roller bracket at different distances, wherein at least one end of the roller mechanism is in contact with one end of the cleaning element.
